(19) United States
(12) Patent Application Publication
(10) Pub. No.: US 2012/0021287 A1
(43) Pub. Date: Jan. 26, 2012

(54) POSITIVE ELECTRODE AND LITHIUM BATTERY INCLUDING THE SAME

(75) Inventors: SOON-REWL LEE, Yongin-si (KR); ICK-KYU CHOI, Yongin-si (KR); YOUNG-KI KIM, Yongin-si (KR); JAY-HYOK SONG, Yongin-si (KR); YOUNG-HUN LEE, Yongin-si (KR); YU-MI SONG, Yongin-si (KR); YOON-CHANG KIM, Yongin-si (KR)

(73) Assignee: SAMSUNG SDI CO., LTD., Yongin-si (KR)

(21) Appl. No.: 13/101,590

(22) Filed: May 5, 2011

(30) Foreign Application Priority Data
Jul. 20, 2010 (KR) 10-2010-0070076

(51) Int. Cl. H01M 4/48; H01M 4/50; H01M 4/58; H01M 4/52

(52) U.S. Cl. 429/220; 429/221; 429/223; 252/182.1

(57) ABSTRACT

Disclosed is a positive electrode and a lithium battery including the positive electrode. The positive electrode includes a first active material represented by Formula 1: Li₂Mo₁₋ₙR¹ₙO₃; a second active material represented by Formula 2: Li₂Ni₁₋ₘR²ₘO₂; and a third active material configured to allow that allows reversible intercalation and deintercalation of lithium ions. In Formula 1, 0≦n<1, and R¹ is selected from the group consisting of manganese (Mn), iron (Fe), cobalt (Co), copper (Cu), zinc (Zn), magnesium (Mg), nickel (Ni), and combinations of at least two of the foregoing elements. In Formula 2, 0≦m<1, and R² is selected from the group consisting of Mn, Fe, Co, Cu, Zn, Mg, molybdenum (Mo), and combinations of at least two of the immediately foregoing elements.

### RELATED APPLICATIONS

This application claims the benefit of Korean Patent Application No. 10-2010-0070076, filed on Jul. 20, 2010, in the Korean Intellectual Property Office, the disclosure of which is incorporated herein in its entirety by reference.

### BACKGROUND

1. Field

The present disclosure relates to a positive electrode and a lithium battery including the positive electrode.

2. Description of the Related Art

A lithium battery converts chemical energy into electrical energy through electrochemical redox reactions between chemical substances. A typical lithium battery includes a positive electrode, a negative electrode, and an electrolyte.

Recently, as electronic devices increasingly demand high performance, batteries for such devices also need high capacity and high power output. In order to provide batteries having high capacity, an active material may need high capacity or a high battery charging voltage. For example, a silicon-based composite material having high capacity may be used as a negative active material for a negative electrode of a battery. However, in silicon-based composite materials intercalation of lithium is irreversible.

### SUMMARY

One or more embodiments of the present invention include a negative electrode having a novel structure, and a lithium battery including the negative electrode.

Additional aspects will be set forth in part in the description which follows and, in part, will be apparent from the description, or may be learned by practice of the presented embodiments.

According to one or more embodiments of the present invention, a positive electrode includes: a first active material represented by Formula 1 below; a second active material represented by Formula 2; and a third active material configured to allow reversible intercalation and deintercalation of lithium ions:

Li₂Mo₁₋ₙR¹ₙO₃ Formula 1

Li₂Ni₁₋ₘR²ₘO₂ Formula 2

In Formula 1, 0≦n≦1 and R¹ is selected from the group consisting of manganese (Mn), iron (Fe), cobalt (Co), copper (Cu), zinc (Zn), magnesium (Mg), nickel (Ni), and combinations of at least two of the foregoing elements. In Formula 2, 0≦m<1 and R² is selected from the group consisting of Mn, Fe, Co, Cu, Zn, Mg, molybdenum (Mo), and combinations of at least two of the immediately foregoing elements.

The first active material may include a Li₂MoO₃-based active material. The second active material may include a Li₂NiO₂-based active material. The second active material may further include a Li₂Ni₈O₁₀ phase. A weight ratio of the first active material to the second active material may be in a range of about 10:90 to about 90:10.

The third active material may include a combination of at least one of the active materials represented by the following Formulae: LiₐA_{1-b}X_{b}D₂, wherein 0.95≦a≦1.1, and 0≦b≦0.5; LiₐE_{1-b}X_{b}O_{2-c}D_{c}, wherein 0.95≦a≦1.1, 0≦b≦0.5, and 0≦c≦0.05; LiE_{2-b}X_{b}O_{4-c}D_{c}, wherein 0≦b≦0.5, and 0≦c≦0.05; LiₐNi_{1-b-c}CO_{b}BcD_{α}, wherein 0.95≦a≦1.1, 0≦b≦0.5, 0≦c≦0.05, and 0<α≦2; LiₐNi_{1-b-c}CO_{b}XₑO_{2-α}M_{α}, wherein 0.95≦a≦1.1, 0≦b≦0.5, 0≦c≦0.05, and 0<α<2; LiₐNi_{1-b-c}CO_{b}X_{c}O₂₋₆₀ M₂, wherein 0.95≦a≦1.1, 0≦b≦0.5, 0≦c≦0.05, and 0<α<2; LiₐNi_{1-b-c}Mn_{b}X_{c}D_{α}, wherein 0.95≦a≦1.1, 0≦b≦0.5, 0≦c≦0.05, and 0<α<2; LiₐNi_{1-b-c}Mn_{b}X_{c}O_{2-α}M_{α}, wherein 0.95≦a≦1.1, 0≦b≦0.5, 0≦c≦0.05, and 0<α<2; LiₐNi_{1-b-c}Mn_{b}X_{c}O_{2-α}M₂, wherein 0.95≦a≦1.1, 0≦b≦0.5, 0≦c≦0.05, and 0<α<2; LiₐNi_{b}E_{c}G_{d}O₂, wherein 0.90≦a≦1.1, 0≦b≦0.9, 0≦c≦0.5, and 0.001≦d≦0.1; LiₐNi_{b}CO_{c}Mn_{d}GₑO₂, wherein 0.90≦a≦1.1, 0≦b≦0.9, 0≦c≦0.5, 0≦d≦0.5, 0≦e≦0.1; LiₐNiG_{b}O₂, wherein 0.90≦a≦1.1, and 0.001≦b≦0.1; LiₐCoG_{b}O₂, wherein 0.90≦a≦1.1, and 0.001≦b≦0.1; LiₐMnG_{b}O₂, wherein 0.90≦a≦1.1, and 0.001≦b≦0.1; LiₐMn₂G_{b}O₄, wherein 0.90≦a≦1.1, and 0≦b≦0.1; QO₂; QS₂; LiQS₂; V₂O₅; LiV₂O₅; LiZO₂; LiNiVO₄; Li_{(3-f)}J₂(PO₄)₃, wherein 0≦f≦2; Li_{(3-f)}Fe₂(PO₄)₃, wherein 0≦f≦2; LiFePO₄; and lithium titanate.

The third active material may include LiCoO₂, LiMn₂O₄, LiFePO₄, a compound represented by Formula 3 below, a compound represented by Formula 4 below, and a combination of at least two of the foregoing materials.

Liₓ(NiₚCO_{q}Mnᵣ)O_{y} Formula 3

LiₙNiₜ₁COₜ₂Alₜ₃Oₘ Formula 4

In Formula 3, 0.95≦x≦1.05, 0<p<1, 0<q<1, 0<r<1, p+q+r=1, and 0<y≦2. In Formula 4, 0.95≦n≦1.05, 0<t1<1, 0<t2<1, 0<t3<1, t1+t2+t3=1, and 0<m≦2. A weight ratio of a mixture of the first and second active materials to the third active material may be in a range of about 1:99 to about 50:50.

According to one or more embodiments of the present invention, a lithium battery includes: a negative electrode including a negative active material; a positive electrode including a first active material represented by Formula 1 below, a second active material represented by Formula 2, and a third active material that allows reversible intercalation and deintercalation of lithium ions; and an electrolyte.

Li₂Mo₁₋ₙR¹ₙO₃ Formula 1

Li₂Ni₁₋ₘR²ₘO₂ Formula 2

In Formula 1, 0≦n<1 and R¹ is selected from the group consisting of manganese (Mn), iron (Fe), cobalt (Co), copper (Cu), zinc (Zn), magnesium (Mg), nickel (Ni), and combinations of at least two of the foregoing elements. In Formula 2, 0≦m<1 and R² is selected from the group consisting of Mn, Fe, Co, Cu, Zn, Mg, molybdenum (Mo), and combinations of at least two of the immediately foregoing elements.

The negative active material may include a material selected from the group consisting of silicon, a silicon-based composite material, tin, a tin-based composite material, lithium titanate, and a combination of at least two of the foregoing materials.

### BRIEF DESCRIPTION OF THE DRAWINGS

These and/or other aspects will become apparent and more readily appreciated from the following description of embodiments, taken in conjunction with the accompanying drawings of which:

FIG. 1 is a schematic cross-sectional view of a structure of an embodiment of a lithium battery;

FIG. 2 is a graph of X-ray diffraction (XRD) analysis data of a Li₂NiO₂-based active material including a Li₂Ni₈O₁₀ phase; and

FIG. 3 is a graph illustrating the cycle lifetime characteristics of lithium batteries according to Example 1 and Comparative Examples 1 to 3.

### DETAILED DESCRIPTION

Reference will now be made in detail to embodiments, some of which are illustrated in the accompanying drawings, wherein like reference numerals refer to like elements throughout. In this regard, the disclosed embodiments may have different forms and should not be construed as being limited to the descriptions set forth herein. Accordingly, embodiments are merely described to explain various aspects and features of the present description.

According to some embodiments, a positive electrode includes a first active material represented by Formula 1 below, a second active material represented by Formula 2, and a third active material that allows reversible intercalation and deintercalation of lithium ions:

Li₂Mo₁₋ₙR¹ₙO₃ Formula 1

Li₂Ni₁₋ₘR²ₘO₂ Formula 2

In Formula 1, 0≦n<1, and R¹ is selected from the group consisting of manganese (Mn), iron (Fe), cobalt (Co), copper (Cu), zinc (Zn), magnesium (Mg), nickel (Ni), and combinations of at least two of the foregoing elements. In Formula 2, 0≦m<1; and R² is selected from the group consisting of Mn, Fe, Co, Cu, Zn, Mg, molybdenum (Mo), and combinations of at least two of the foregoing elements.

For example, the first active material may be a Li₂MoO₃-based active material. The term “Li₂MoO₃-based active material” used herein refers to a material including a Li₂MoO₃ compound. While containing the Li₂MoO₃ compound, the “Li₂MoO₃-based active material” may further include a layer and/or phase that are of a different stoichiometry from the Li₂MoO₃ compound. In addition, the term “-based active material” used herein may be construed in the similar way. The first active material may be a material capable of irreversibly deintercalating lithium ion.

The second active material may be a Li₂NiO₂-based active material. The Li₂NiO₂-based active material may also be a material capable of irreversibly deintercalating lithium ion.

The first active material and the second active material may be capable of irreversibly deintercalating lithium ions. For example, the first active material and the second active material deintercalate lithium ions into a negative electrode during the initial charging of the battery. In other words, during the initial charging, the positive electrode provides for the first time lithium ions to the negative electrode. However, the reversibility in a discharge following the initial charge becomes low. For example, the reversibility is about 5% to about 25% at a discharge cut-off voltage of 3V, and this may vary depending on the ratio of the first active material and the second active material. For example, the reversibility may be almost 0%.

The third active material allows reversible intercalation and deintercalation of lithium ions and is substantially involved in charge-discharge cycles following the initial charging of the battery.

Thus, if a positive electrode including the first active material and the second active material is used with a negative electrode including a negative active material capable of irreversibly deintercalating lithium ions, the irreversibility of the negative electrode may be compensated, and thus, the capacity retention rate of the lithium battery may be improved. This is supported by the following explanations.

For example, let's consider a lithium battery L1 that includes a positive electrode made of only the third active material as a positive active material and a negative electrode made of a negative active material capable of deterintercalating 80% of the lithium ions received from the positive electrode during an initial charge. If the third active material deintercalates 100 lithium ions during the initial charge, the negative electrode may, in theory, deintercalate 80 lithium ions during the discharge.

Meanwhile, for comparison, let's consider a lithium battery L2 that is identical to the lithium battery L1, except that the positive electrode active material further includes a first active material and a second active material which both can irreversibly deintercalate 20 lithium ions during the initial charging. The positive electrode can provide 120 lithium ions, (rather than 100 lithium ions) to the negative electrode during the initial charge. Thus, the negative electrode may, in theory, deintercalate 96 (=120×0.8) lithium ions during the discharge. In other words, adding the first active material and the second active material to the positive electrode of the lithium battery L2 may compensate for some of the irreversibility of the negative electrode. Thus, the lithium battery L2 may have good capacity retention wile maintaining substantially the same capacity as the lithium battery L1

In embodiments, the first active material may suppress or substantially prevent generation of gas from the second active material. The second active material, for example, a Li₂NiO₂-based active material, may irreversibly discharge a large number of lithium ions and may also generate gases. For example, a Li₂NiO₂-based active material used as the second active material may generate O₂ according to Reaction 1:

Li₂NiO₂ NiO+O+2Li Reaction 1

The resulting oxygen (O) and lithium (2Li) of Reaction 1 then generate Li₂O, which then may react with one or more components of the electrolyte, conducting agent, and/or various additives to produce Li₂CO₃, which may release CO₂.

As described above, the second active material, for example, the Li₂NiO₂-based active material, can irreversibly deintercalate lithium ions, which may generate O₂ and/or CO₂ in the lithium battery.

While the second active material, for example, the Li₂NiO₂-based active material, releases O₂ through Reaction 1, the first active material, for example, a Li₂MoO₃-based active material, irreversibly deintercalates lithium ions and simultaneously absorbs O₂. In other words, although O₂ may be released from the second active material, the first active material can absorb O₂ generated from the second active material, and thus practically reduces overall generation of gas in the lithium battery.

Thus, the positive electrode may effectively compensate for the irreversibility characteristic of the negative electrode and may improve safety of the lithium battery.

The second active material, for example, a Li₂NiO₂-based active material, may further include a Li₂Ni₈O₁₀ phase. For example, if a Li₂NiO₂-based active material used as the second active material further includes the Li₂Ni₈O₁₀ phase, it is understood that the phase of the second material may be stabilized, and thus, such an additional reaction as Reaction 1 may be suppressed or substantially prevented. Since the use of the Li₂Ni₈O₁₀ phase may substantially suppress or prevent Reaction 1 induced by the second active material, for example, the Li₂NiO₂-based active material, the lithium battery may have improved safety.

The Li₂Ni₈O₁₀ phase may be obtained by adjusting or controlling heat-treatment conditions for synthesis of the second active material, for example, a Li₂NiO₂-based active material. For example, Li₂O and NiO are mixed in a stoichiometric ratio (1:1 molar ratio), and the resulting mixture is heat-treated under inert atmospheric conditions (for example, a N₂ atmosphere) at one or more temperatures from about 500° C. to 600° C. (for example, about 550° C.) for about 5 hours to about 15 hours (for example, about 10 hours). The heat-treated material may be cooled to a temperature ranging from room temperature to 100° C. Then the resulting material is further heat treated under inert atmospheric conditions (for example, a N₂ atmosphere) at one or more temperatures from about 500° C. to about 600° C. (for example, about 550° C.) for about 5 hours to about 15 hours (for example, about 10 hours), which provide the Li₂NiO₂-based active material including a Li₂Ni₈O₁₀ phase.

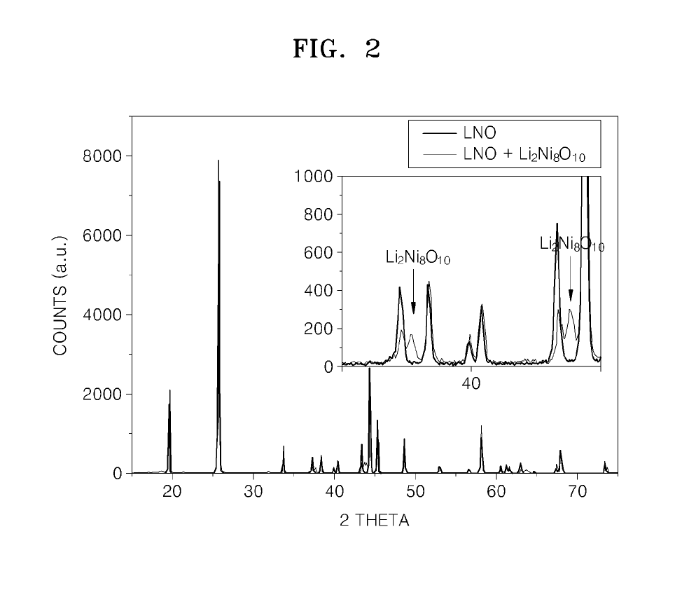

FIG. 2 is a graph of X-ray diffraction (XRD) analysis of a Li₂NiO₂-based active material prepared by thermally treating a mixture of Li₂O and NiO in a stoichiometric ratio (1:1 molar ratio) in a N₂ atmosphere at 550° C. for 10 hours and then further at 550° C. for 10 hours. FIG. 2 confirms the presence of a Li₂Ni₈O₁₀ phase.

The first active material and the second active material may be used in a weight ratio of about 10:90 to about 90:10. For example, the first active material and the second active material may be used in a weight ratio of about 75:15 to about 50:50. When the weight ratio of the first active material to the second active material is within these ranges, lithium ions may be fully irreversibly deintercalated, and gas such as O₂, CO₂ or the like may be substantially prevented from being generated.

The third active material may be any active material known in the art that allows reversible intercalation and deintercalation of lithium ions. The third active material is substantially involved in charge-discharge cycles.

For example, the third active material may be any combination of at least one of the active materials represented by the following formulae; however, any suitable active material may be used:

LiₐA_{1-b}X_{b}D₂, wherein 0.95≦a≦1.1, and 0≦b≦0.5; LiₐE_{1-b}X_{b}O_{2-c}D_{c}, wherein 0.95≦a≦1.1, 0≦b≦0.5, and 0≦c≦0.05; LiE_{2-b}X_{b}O_{4-c}D_{c}, wherein 0≦b≦0.5, and 0≦c≦0.05; LiₐNi_{1-b-c}CO_{b}BcD_{α}, wherein 0.95≦a≦1.1, 0≦b≦0.5, 0≦c≦0.05, and 0<α<2; LiₐNi_{1-b-c}CO_{b}X_{c}O_{2-α}M_{α}, wherein 0.95≦a≦1.1, 0≦b≦0.5, 0≦c≦0.05, and 0<α<2; LiₐNi_{1-b-c}CO_{b}X_{c}O_{2-α}M₂, wherein 0.95≦a≦1.1, 0≦b≦0.5, 0≦c≦0.05, and 0<α<2; LiₐNi_{1-b-c}Mn_{b}X_{c}D_{α} wherein 0.95≦a≦1.1, 0≦b≦0.5, 0≦c≦0.05, and 0<α<2; LiₐNi_{1-b-c}Mn_{b}X_{c}O_{2-α}M_{α}, wherein 0.95≦a≦1.1, 0<b≦0.5, 0≦c≦0.05, and 0<α<2; LiₐNi_{1-b-c}Mn_{b}X_{c}O_{2-α}M₂, wherein 0.95≦a≦1.1, 0≦b≦0.5, 0≦c≦0.05, and 0<α<2; LiₐNi_{b}E_{c}G_{d}O₂, wherein 0.90≦a≦1.1, 0≦b≦0.9, 0≦c≦0.5, and 0.001≦d≦0.1; LiₐNi_{b}CO_{c}Mn_{d}GₑO₂, wherein 0.90≦a≦1.1, 0≦b≦0.9, 0≦c≦0.5, 0≦d≦0.5, 0≦e≦0.1; LiₐNiG_{b}O₂, wherein 0.90≦a≦1.1, and 0.001≦b≦0.1; LiₐCoG_{b}O₂, wherein 0.90≦a≦1.1, and 0.001≦b≦0.1; LiₐMnG_{b}O₂, wherein 0.90≦a≦1.1, and 0.001≦b≦0.1; LiₐMn₂G_{b}O₄, wherein 0.90≦a≦1.1, and 0≦b≦0.1; QO₂; QS₂; LiQS₂; V₂O₅; LiV₂O₅; LiZO₂; LiNiVO₄; Li_{(3-f)}J₂(PO₄)₃, wherein 0≦f≦2; Li_{(3-f)}Fe₂(PO₄)₃, wherein 0≦f≦2; LiFePO₄; and lithium titanate.

In the above formulae, A is selected from the group consisting of nickel (Ni), cobalt (Co), manganese (Mn), and combinations thereof; X is selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D is selected from the group consisting of oxygen (O), fluorine (F), sulfur (S), phosphorus (P), and combinations thereof; E is selected from the group consisting of cobalt (Co), manganese (Mn), and a combination thereof; M is selected from the group consisting of fluorine (F), sulfur (S), phosphorus (P), and combinations thereof; G is selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q is selected from the group consisting of titanium (Ti), molybdenum (Mo), manganese (Mn), and combinations thereof; Z is selected from the group consisting of chromium (Cr), vanadium (V), iron (Fe), scandium (Sc), yttrium (Y), and combinations thereof; and J is selected from the group consisting of vanadium (V), chromium (Cr), manganese (Mn), cobalt (Co), nickel (Ni), copper (Cu), and combinations thereof.

Examples of the third active material include LiCoO₂, LiMn₂O₄, LiFePO₄, a compound represented by Formula 3 below, a compound represented by Formula 4 below, and a combination of at least two of the foregoing compounds. However, any suitable active material may be used.

Liₓ(NiₚCO_{q}Mnᵣ)O_{y} Formula 3

LiₙNiₜ₁COₜ₂Alₜ₃Oₘ Formula 4

In Formula 3, 0.95≦x≦1.05, 0<p<1, 0<q<1, 0<r<1, p+q+r=1, and 0<y≦2. In Formula 4, 0.95≦n≦1.05, 0<t1<1, 0<t2<1, 0<t3<1, t1+t2+t3=1, and 0<m≦2. In Formulae 3 and 4, x, p, q, r, y, n, t1, t2, t3, and m indicate molar ratios of the elements.

For example, 0.97≦x≦1.03, p may be 0.5, q may be 0.2, r may be 0.3, and y may be 2. However, x, p, q, r and y may be appropriately varied. For example, the active material of Formula 3 may be a LiNi_{0.5}Cu_{0.2}Mn_{0.3}O₂ compound. However, any suitable active material according to Formula 3 may be used.

For example, in Formula 4, t1+t2+t3=1. However, t1, t2 and t3 may be appropriately varied. For example, in the third active material of Formula 4, n=1, m=2, and t1=t2=t3.

A mixture of the first and second active materials, and the third active material may be used in a weight ratio of about 1:99 to about 50:50. For example, the mixture of the first and second active materials, and the third active material may be used in a weight ratio of about 5:95 to about 20:80. When the weight ratio of the mixture of the first and second active materials to the third active material is within these ranges, the lithium battery may have high discharge capacity and an improved charge retention rate.

According to some embodiments, a lithium battery includes a negative electrode, a positive electrode and an electrolyte. The positive electrode contains a first active material represented by Formula 1 above, a second active material represented by Formula 2 above, and a third active material that allows reversible intercalation and deintercalation of lithium ions.

The negative electrode includes a negative active material. The negative active material may be selected from various negative active materials suitable for lithium batteries. For example, the negative active material may be a negative active material having high capacity. For example, the negative active material may be a material that has high capacity, but allows irreversible deintercalation of lithium ions.

Examples of the negative active material include silicon, a silicon-based composite material, tin, a tin-based composite material, lithium titanate, and a combination of at least two of these materials. However, any suitable material may be used.

For example, the negative electrode may include a silicon thin film or a silicon-based composite material. The silicon-based composite material may contain silicon and at least one non-silicon material and/or element. For example, the silicon-based composite material is selected from the group consisting of a silicon oxide, a silicon-graphite composite material, a silicon oxide-graphite composite material, a silicon-carbon nanotube composite material, a silicon oxide-carbon nanotube composite material, and a material represented as Si-M₁ wherein M₁ is selected from the group consisting of Al, Sn, Ag, Fe, Bi, Mg, Zn, In, Ge, Pb, Ti, and a combination of at least two of these elements. However, any suitable material may be used.

In the silicon thin film or the silicon-based composite material that has high capacity, a Lewis' acid, such as PF₅ or HF can be produced when a lithium salt is decomposed in the electrolyte during charge and discharge cycles and the Lewis' acid may break down a Si—Si bonding and irreversibly form Si—F bonds. Si—F bonds have a strong binding force and are stable, and thus, cause irreversible reactions in the negative electrode.

For example, the tin-based composite material is selected from the group consisting of a tin-graphite composite material, a tin-carbon nanotube composite material, and a material represented as Sn-M₂ wherein M₂ is selected from the group consisting of Al, Si, Ag, Fe, Bi, Mg, Zn, In, Ge, Pb, Ti and a combination of at least two of these elements. However, any suitable material may be used.

Examples of the lithium titanate include spinel-structured lithium titanate, anatase-structured lithium titanate, and ramsdellite-structured lithium titanate, which are classified according to their crystal structures.

For example, the negative active material may be Li₄₋ₓTi₅O₁₂(0≦x≦3). For example, the negative active material may be Li₄Ti₅O₁₂. However, any suitable material may be used.

Similar to the silicon-based thin film or silicon-based composite material, tin, tin-based composite materials, and lithium titanate have high capacity, but irreversibly deintercalate lithium ions, and thus, may have a poor capacity retention rate.

However, if the above-described negative electrode with high capacity and poor capacity retention rate is used in a lithium battery with the positive electrode including all the first active material, the second active material and the third active material, the lithium battery may have high capacity characteristics and a good capacity retention rate. This is because the negative electrode is provided with the lithium ions irreversibly deintercated by the first active material and the second active material of the positive electrode. The positive electrode described above may be implemented in various forms. According to embodiments of the positive electrode, gas generation in a lithium battery including the positive electrode may be suppressed, and the lithium battery may have improved stability.

The electrolyte may include a nonaqueous organic solvent and a lithium salt. The nonaqueous organic solvent in the electrolyte may function as a migration medium of ions involved in electrochemical reactions of the lithium battery. Examples of the nonaqueous organic solvent include a carbonate-based solvent, an ester-based solvent, an ether-based solvent, a ketone-based solvent, an alcohol-based solvent, and an aprotic solvent.

Examples of the carbonate-based solvent include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and butylene carbonate (BC). However, any suitable carbonate-based solvent may be used.

Examples of the ester-based solvent include methyl acetate, ethyl acetate, n-propyl acetate, dimethyl acetate, methyl propionate, ethyl propionate, γ-butyrolactone (GBL), decanolide, valerolactone, mevalonolactone, and caprolactone. However, any suitable ester-based solvent may be used.

Examples of the ether-based solvent include dibutyl ether, tetraglyme, diglyme, dimethoxy ethane, 2-methyltetrahydrofuran, and tetrahydrofuran. However, any suitable ether-based solvent may be used.

An example of the ketone-based solvent is cyclohexanone. However, any suitable ketone-based solvent may be used.

Examples of the alcohol-based solvent include ethyl alcohol, and isopropyl alcohol. However, any suitable alcohol-based solvent may be used.

Examples of the aprotic solvent include nitriles (such as R—CN, where R is a C₂-C₂₀ linear, branched, or cyclic hydrocarbon-based moiety that may include an double-bonded aromatic ring or an ether bond), amides (such as dimethylformamide), dioxolanes (such as 1,3-dioxolane), and sulfolanes. However, any suitable aprotic solvent may be used.

The nonaqueous organic solvent may include a single solvent used alone or a combination of at least two solvents. If a combination of solvents is used, the ratio of the nonaqueous organic solvents may vary according to the desired performance of the lithium battery, which will be obvious to one of ordinary skill in the art. For example, the nonaqueous organic solvent may be a mixture of ethylene carbonate (EC) and ethylmethyl carbonate (EMC) in a volume ratio of about 3:7. For example, the nonaqueous organic solvent may be a mixture of EC, GBL, and EMC in a volume ratio of about 3:3:4.

The lithium salt in the electrolyte solution is dissolved in the nonaqueous organic solvent and functions as a source of lithium ions in the lithium battery and accelerates the migration of lithium ions between the positive electrode and the negative electrode. For example, the lithium salt may include at least one supporting electrolyte salt selected from the group consisting of LiPF₆, LiBF₄, LiSbF₆, LiAsF₆, LiN (SO₂C₂E₅)₂, Li (CF₃SO₂)₂N, LiC₄F₉SO₃, LiClO₄, LiAlO₂, LiAlCl₄, LiN (CₓF₂ₓ₊₁SO₂)(C_{y}F_{2y+1}SO₂), where x and y are each independently a natural number, LiCl, LiI, and LiB (C₂O₄)₂ (lithium bis(oxalato) borate or LiBOB). Also, combinations of the foregoing salts may be used as an electrolyte.

The concentration of the lithium salt may be in a range of about 0.1M to about 2.0 M. For example, the concentration of the lithium salt may be about 0.6 M to about 2.0 M. When the concentration of the lithium salt is within these ranges, the electrolyte may have the desired conductivity and viscosity, and thus lithium ions may efficiently migrate.

The electrolyte may further include an additive capable of improving the low-temperature performance of the lithium battery. Examples of the additive include a carbonate-based material and propane sulton (PS). However, any suitable additive may be used. Furthermore, one additive may be used, or a combination of additives may be used.

Examples of the carbonate-based material include vinylene carbonate (VC); vinylene carbonate (VC) derivatives having at least one substituent selected from the group consisting of halogen atoms (such as F, Cl, Br, and I), cyano groups (CN), and nitro groups (NO₂); and ethylene carbonate (EC) derivatives having at least one substitutent selected from the group consisting of halogen atoms (such as F, Cl, Br, and I), cyano groups (CN), and nitro groups (NO₂). However, any suitable carbonate-based material may be used.

The electrolyte may further include at least one additive selected from the group consisting of vinylene carbonate (VC), fluoroethylene carbonate (FEC), and propane sulton (PS).

The amount of the additive may be about 10 parts or less by weight based on 100 parts by weight of the total amount of the nonaqueous organic solvent and the lithium salt. For example, the amount of the additive may be in a range of about 0.1 parts by weight to about 10 parts by weight based on 100 parts by weight of the total amount of the nonaqueous organic solvent and the lithium salt. When the amount of the additive is within these ranges, the lithium battery may have satisfactorily improved low-temperature characteristics.

For example, the amount of the additive may be in a range of about 1 part by weight to about 5 parts by weight based on 100 parts by weight of the total amount of the nonaqueous organic solvent and the lithium salt. The amount of the additive may be in a range of about 2 parts by weight to about 4 parts by weight, based on 100 parts by weight of the total amount of the nonaqueous organic solvent and the lithium salt.

For example, the amount of the additive may be about 2 parts by weight based on 100 parts by weight of the total amount of the nonaqueous organic solvent and the lithium salt.

In embodiments, a separator may be positioned between the positive electrode and the negative electrode. Any separator commonly used for lithium batteries may be used. In an embodiment, the separator may have low resistance to the migration of ions in an electrolyte and a high electrolyte-retaining ability. Examples of materials used to form the separator include glass fiber, polyester, Teflon, polyethylene, polypropylene, polytetrafluoroethylene (PTFE), and combinations thereof, each of which may be a nonwoven or woven fabric. In one embodiment, a rollable separator formed of a material such as polyethylene and polypropylene may be used for lithium ion batteries. In another embodiment, a separator capable of retaining a large amount of an organic electrolyte may be used for lithium ion polymer batteries. These separators may be prepared according to the following process.

A polymer resin, a filler, and a solvent are mixed to prepare a separator composition. Then, the separator composition may be coated directly on an electrode, and then dried to form a separator film. Alternatively, the separator composition may be cast on a separate support and then dried to form a separator composition film, which is then removed from the support and laminated on an electrode to form a separator film.

The polymer resin may be any material commonly used as a binder for electrode plates. Examples of the polymer resin include a vinylidenefluoride/hexafluoropropylene copolymer, polyvinylidenefluoride, polyacrylonitrile, polymethylmethacrylate, and mixtures thereof. However, any suitable polymer resin may be used. For example, a vinylidenefluoride/hexafluoropropylene copolymer containing about 8 to about 25 wt % of hexafluoropropylene may be used.

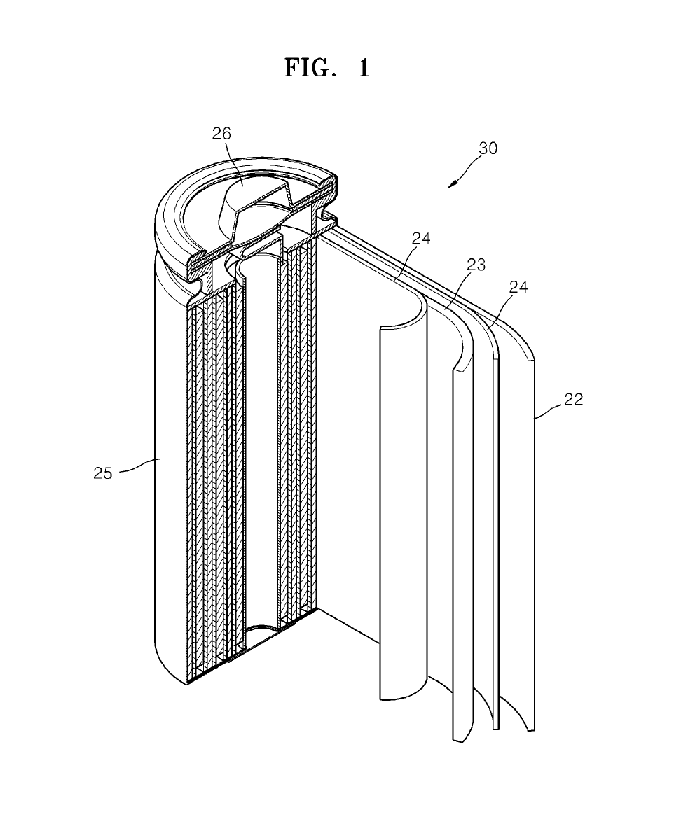

FIG. 1 is a schematic perspective view of a lithium battery 30 according to an embodiment of the present invention. Referring to FIG. 1, the lithium battery 30 includes an electrode assembly having a positive electrode 23, a negative electrode 22, and a separator 24 between the positive electrode 23 and the negative electrode 22. The electrode assembly is contained within a battery case 25, and a sealing member 26 seals the battery case 25. An electrolyte (not shown) is injected into the battery case 25 to impregnate the electrolyte assembly. The lithium battery 30 is manufactured by sequentially stacking the positive electrode 23, the negative electrode 22, and the separator 24 on one another to form a stack, rolling the stack, and inserting the rolled up stack into the battery case 25.

The type of the lithium battery is not particularly limited, and may be, for example, a lithium secondary battery such as a lithium ion battery, a lithium ion polymer battery, a lithium sulfur battery, or the like, or a lithium primary battery.

A method of manufacturing the lithium battery will now be described in detail. According to embodiments, a method of manufacturing the positive electrode involves mixing active materials (i.e., the first active material of Formula 1, the second active material of Formula 2, and the third active material described above) with a binder and a solvent to prepare a positive active material composition. Then, the positive active material composition is coated directly on a current collector (for example, an aluminum current collector) and then dried to form a positive active material layer, thereby completing the manufacture of a positive electrode plate.

The current collector may be any one selected from the group consisting of a copper foil, a nickel foil, a stainless steel foil, a titanium foil, a nickel foam, a copper foam, and a polymeric substrate coated with a conductive metal. However, any current collector may be used. Alternatively, the current collector may be manufactured from a mixture of the materials listed above or by stacking substrates made from the materials on one another. According to embodiments, the current collector may have any of a variety of structures.

Alternatively, the positive active material composition may be cast on a separate support to form a positive active material film, which is then separated from the support and laminated on the positive electrode current collector to prepare a positive electrode plate. Non-limiting examples of suitable solvents include N-methylpyrrolidone, acetone, water, and the like.

The binder in the positive active material layer strongly binds positive active material particles together and to the current collector. Non-limiting examples of the binder include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The positive active material layer may further include a conducting agent for providing conductivity to the positive electrode. Any electron conducting material that would not induce chemical changes may be used. Examples of the conducting agent may include carbonaceous materials, such as natural graphite, artificial graphite, carbon black, acetylene black, ketjen black, carbon fibers, and the like; metal-based materials, such as copper (Cu), nickel (Ni), aluminum (Al), silver (Ag), and the like, in powder or fiber form; and conductive materials, including conductive polymers, such as a polyphenylene derivative, and mixtures thereof.

The current collector may be aluminum (Al). However, any suitable material may be used.

Similarly, a negative active material, a conducting agent, a binder, and a solvent are mixed to prepare a negative active material composition. The negative active material composition is coated directly on a current collector (for example, a Cu current collector), or is cast on a separate support to form a negative active material film, which is then separated from the support and laminated on a Cu current collector to obtain a negative electrode plate. In this regard, the amounts of the negative active material, the conducting agent, the binder, and the solvent may be amounts commonly used in lithium batteries. According to embodiments, the negative electrode may be manufactured using plating or any of a variety of known methods.

In embodiments, the conducting agent, the binder, and the solvent in the negative active material composition may be the same as those used in the positive active material composition. If required, a plasticizer may be further added to each of the positive electrode active material composition and the negative electrode active material composition to produce pores in the electrode plates.

The separator is positioned between the positive electrode plate and the negative electrode plate to form a battery assembly, which is then wound or folded. The primary assembly is then encased in a cylindrical or rectangular battery case. Then, an electrolyte is injected into the battery case, thereby completing the manufacture of a lithium battery assembly.

Hereinafter, one or more embodiments of the present invention will be described in more detail with reference to the following examples. However, these examples are not intended to limit the scope of the present invention.

### EXAMPLES

### Example 1

A SiOₓ negative active material and a polyvinylidene fluoride (PVDF) binder were mixed in weight ratio of 90:10 in an N-methylpyrrolidone solvent to prepare a negative electrode slurry. The negative electrode slurry was coated on a copper (Cu)-foil to form a thin anode plate having thickness of 14 μm, and dried at 135° C. for 20 minutes to provide a negative electrode.

A positive active material mixture of Li₂MoO₃, Li₂NiO₂ and LiCoO₂ (in weight ratio of 15:5:80), a PVDF binder, and a carbon conducting agent (an acetylene black, DENKA BLACK) were dispersed in weight ratio of 96:2:2 in an N-methylpyrrolidone solvent to prepare a positive active material layer composition. The positive active material layer composition was coated on an aluminum (Al)-foil to form a thin positive electrode plate having thickness of 60 μm, which is then dried at 135° C. for 20 minutes and pressed to manufacture a positive electrode having thickness of 35 μm.

1.0M LiPF₆ was added to a mixture of ethylene carbonate (EC) and ethylmethyl carbonate (EMC) (in volume ratio of 3:7) to prepare an electrolyte.

The negative electrode, the positive electrode, the electrolyte, and a porous polyethylene (PE) separator film were assembled to manufacture a coin cell battery.

### Comparative Example 1

A lithium battery was manufactured in the same manner as in Example 1, except that a mixture of Li₂MoO₃ and LiCoO₂ (in weight ratio of 20:80) was used, instead of the mixture of Li₂MoO₃, Li₂NiO₂, and LiCoO₂, to prepare the positive active material layer composition.

### Comparative Example 2

A lithium battery was manufactured in the same manner as in Example 1, except that a mixture of Li₂NiO₂ and LiCoO₂ (in weight ratio of 10:90) was used, instead of the mixture of Li₂MoO₃, Li₂NiO₂, and LiCoO₂, to prepare the positive active material layer composition.

### Comparative Example 3

A lithium battery was manufactured in the same manner as in Example 1, except that LiCoO₂ was used, instead of the mixture of Li₂MoO₃, Li₂NiO₂, and LiCoO₂, to prepare the positive active material layer composition.

### Evaluation Example

The lithium batteries of Example 1 and Comparative Examples 1 to 3 were left at room temperature (25° C.) for 20 hours and were then subjected to charging and discharging (formation process) at the rate of 0.05 C. After completion of the formation process, the lithium batteries were charged in a constant current/constant voltage (CC/CV) mode at the rate of 0.6 C, charge voltage of 4.35V and charge cut-off current of 0.06 C and then discharged at rate of 1 C and a discharge cut-off voltage of 2.5V. This charge and discharge cycle was repeated to measure the capacity and 0.6 C/1 C cycle lifetime of each of the lithium batteries. The 0.6 C/1 C cycle lifetime was measured as a relative capacity percentage with respect to the overall initial cycle capacity.

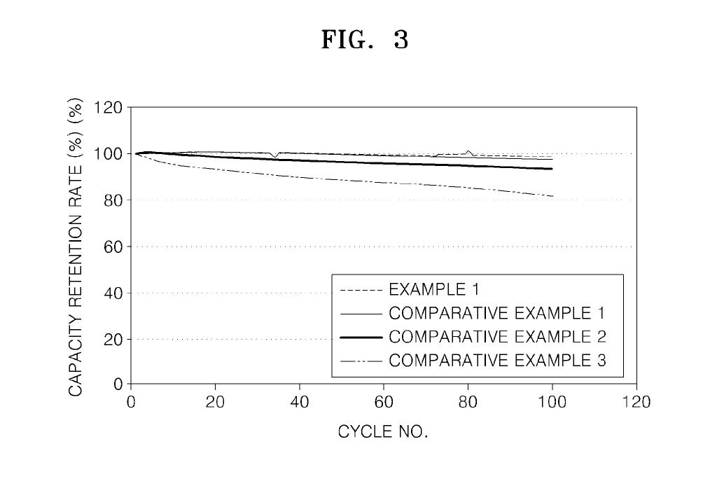

The results are shown in FIG. 3. Referring to FIG. 3, the lithium battery of Example 1 shows better lifetime characteristics than the lithium batteries of Comparative Examples 1 to 3.

As described above, a lithium battery including the positive electrode according to embodiments may have good capacity retention characteristics and stability even when using a negative electrode including a negative active material that irreversibly deintercalates lithium ions.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A positive electrode comprising:
a first active material represented by Formula 1 below;
a second active material represented by Formula 2; and
a third active material configured to allow reversible intercalation and deintercalation of lithium ions,
Li₂Mo₁₋ₙR¹ₙO₃ Formula 1
Li₂Ni₁₋ₘR²ₘO₂ Formula 2
wherein, in Formula 1, 0≦n<1 and R¹ is selected from the group consisting of manganese (Mn), iron (Fe), cobalt (Co), copper (Cu), zinc (Zn), magnesium (Mg), nickel (Ni), and combinations of at least two of the foregoing elements, and
wherein, in Formula 2, 0≦m<1 and R² is selected from the group consisting of Mn, Fe, Co, Cu, Zn, Mg, molybdenum (Mo), and combinations of at least two of the immediately foregoing elements.

2. The positive electrode of claim 1, wherein the first active material comprises a Li₂MoO₃-based active material.

3. The positive electrode of claim 1, wherein the second active material comprises a Li₂NiO₂-based active material.

4. The positive electrode of claim 4, wherein the second active material further comprises a Li₂Ni₈O₁₀ phase.

5. The positive electrode of claim 1, wherein a weight ratio of the first active material to the second active material is in a range of about 10:90 to about 90:10.

6. The positive electrode of claim 1, wherein the third active material comprises at least one selected from the group consisting of active materials represented by the following Formulae:
LiₐA_{1-b}X_{b}D₂,
wherein 0.95≦a≦1.1, and 0≦b≦0.5;
LiₐE_{1-b}X_{b}O_{2-c}Dₑ,
wherein 0.95≦a≦1.1, 0≦b≦0.5, and 0≦c≦0.05;
LiE_{2-b}X_{b}O_{4-c}D_{c},
wherein 0≦b≦0.5, and 0≦c≦0.05;
LiₐNi_{1-b-c}CO_{b}BcD_{α},
wherein 0.95≦a≦1.1, 0≦b≦0.5, 0≦c≦0.05, and 0<α<2;
LiₐNi_{1-b-c}CO_{b}X_{c}O_{2-α}M_{α},
wherein 0.95≦a≦1.1, 0≦b≦0.5, 0≦c≦0.05, and 0<α<2;
LiₐNi_{1-b-c}CO_{b}X_{c}O_{2-α}M₂,
wherein 0.95≦a≦1.1, 0≦b≦0.5, 0≦c≦0.05, and 0<α<2;
LiₐNi_{1-b-c}Mn_{b}X_{c}Dₐ,
wherein 0.95≦a≦1.1, 0≦b≦0.5, 0≦c≦0.05, and 0<α<2;
LiₐNi_{1-b-c}Mn_{b}X_{c}O_{2-α}M_{α},
wherein 0.95≦a≦1.1, 0≦b≦0.5, 0≦c≦0.05, and 0<α<2;
LiₐNi_{1-b-c}Mn_{b}X_{c}O_{2-α}M₂,
wherein 0.95≦a≦1.1, 0≦b≦0.5, 0≦c≦0.05, and 0<α<2;
LiₐNi_{b}E_{c}G_{d}O₂,
wherein 0.90≦a≦1.1, 0≦b≦0.9, 0≦c≦0.5, and 0.001≦d≦0.1;
LiₐNi_{b}CO_{c}Mn_{d}GₑO₂,
wherein 0.90≦a≦1.1, 0≦b≦0.9, 0≦c≦0.5, 0≦d≦0.5, 0≦e≦0.1;
LiₐNiG_{b}O₂,
wherein 0.90≦a≦1.1, and 0.001≦b≦0.1;
LiₐCoG_{b}O₂,
wherein 0.90≦a≦1.1, and 0.001≦b≦0.1;
LiₐMnG_{b}O₂,
wherein 0.90≦a≦1.1, and 0.001≦b≦0.1;
LiₐMn₂G_{b}O₄,
wherein 0.90≦a≦1.1, and 0≦b≦0.1;
QO₂;
QS₂;
LiQS₂;
V₂O₅;
LiV₂O₅;
LiZO₂;
LiNiVO₄;
Li_{(3-f)}J₂(PO₄)₃,
wherein 0≦f≦2;
Li_{(3-f)}Fe₂(PO₄)₃,
wherein 0≦f≦2;
LiFePO₄; and
lithium titanate.

7. The positive electrode of claim 1, wherein the third active material comprises at least one selected from the group consisting of LiCoO₂, LiMn₂O₄, LiFePO₄, a compound represented by Formula 3 below, and a compound represented by Formula 4 below:
Liₓ(NiₚCO_{q}Mnᵣ)O_{y} Formula 3
LiₙNiₜ₁COₜ₂Alₜ₃Oₘ Formula 4
wherein, in Formula 3, 0.95≦x≦1.05, 0<p<1, 0<q<1, 0<r<1, p+q+r=1, and 0<y≦2, and
wherein, in Formula 4, 0.95≦n≦1.05, 0<t1<1, 0<t2<1, 0<t3<1, t1+t2+t3=1, and 0<m≦2.

7. The positive electrode of claim 1, wherein a weight ratio of a mixture of the first and second active materials to the third active material is in a range of about 1:99 to about 50:50.

8. A lithium battery comprising:
a negative electrode comprising a negative active material;
a positive electrode comprising a first active material represented by Formula 1 below, a second active material represented by Formula 2, and a third active material configured to allow reversible intercalation and deintercalation of lithium ions; and
an electrolyte.
Li₂Mo₁₋ₙR¹ₙO₃ Formula 1
Li₂Ni₁₋ₘR²ₘO₂ Formula 2
wherein, in Formula 1, 0≦n<1, and R¹ is selected from the group consisting of manganese (Mn), iron (Fe), cobalt (Co), copper (Cu), zinc (Zn), magnesium (Mg), nickel (Ni), and combinations of at least two of the foregoing elements, and
wherein, in Formula 2, 0≦m<1, and R² is selected from the group consisting of Mn, Fe, Co, Cu, Zn, Mg, molybdenum (Mo), and combinations of at least two of the immediately foregoing elements.

9. The lithium battery of claim 9, wherein the first active material comprises a Li₂MoO₃-based active material.

10. The lithium battery of claim 9, wherein the second active material comprises a Li₂NiO₂-based active material.

11. The lithium battery of claim 11, wherein the second active material further comprises a Li₂Ni₈O₁₀ phase.

12. The lithium battery of claim 9, wherein a weight ratio of the first active material to the second active material is in a range of about 10:90 to about 90:10.

13. The lithium battery of claim 9, wherein the third active material comprises at least one of the active materials represented by the following Formulae:
LiₐA_{1-b}X_{b}D₂,
wherein 0.95≦a≦1.1, and 0≦b≦0.5;
LiₐE_{1-b}X_{b}O_{2-c}D_{c},
wherein 0.95≦a≦1.1, 0≦b≦0.5, and 0≦c≦0.05;
LiE_{2-b}X_{b}O_{4-c}D_{c},
wherein 0≦b≦0.5, and 0≦c≦0.05;
LiₐNi_{1-b-c}CO_{b}BcD_{α},
wherein 0.95≦a≦1.1, 0≦b≦0.5, 0≦c≦0.05, and 0<α<2;
LiₐNi_{1-b-c}CO_{b}X_{c}O_{2-α}M_{α},
wherein 0.95≦a≦1.1, 0≦b≦0.5, 0≦c≦0.05, and 0<α<2;
LiₐNi_{1-b-c}CO_{b}X_{c}O_{2-α}M₂,
wherein 0.95≦a≦1.1, 0≦b≦0.5, 0≦c≦0.05, and 0<α<2;
LiₐNi_{1-b-c}Mn_{b}X_{c}D_{α},
wherein 0.95≦a≦1.1, 0≦b≦0.5, 0≦c≦0.05, and 0<α<2;
LiₐNi_{1-b-c}Mn_{b}X_{c}O_{2-α}M_{α},
wherein 0.95≦a≦1.1, 0≦b≦0.5, 0≦c≦0.05, and 0<α<
LiₐNi_{1-b-c}Mn_{b}X_{c}O_{2-α}M₂,
wherein 0.95≦a≦1.1, 0≦b≦0.5, 0≦c≦0.05, and 0<α<2;
LiₐNi_{b}E_{c}G_{d}O₂,
wherein 0.90≦a≦1.1, 0≦b≦0.9, 0≦c≦0.5, and 0.001≦d≦0.1;
LiₐNi_{b}CO_{c}Mn_{d}GₑO₂,
wherein 0.90≦a≦1.1, 0≦b≦0.9, 0≦c≦0.5, 0≦d≦0.5, 0≦e≦0.1;
LiₐNiG_{b}O₂,
wherein 0.90≦a≦1.1, and 0.001≦b≦0.1;
LiₐCoG_{b}O₂,
wherein 0.90≦a≦1.1, and 0.001≦b≦0.1;
LiₐMnG_{b}O₂,
wherein 0.90≦a≦1.1, and 0.001≦b≦0.1;
LiₐMn₂G_{b}O₄,
wherein 0.90≦a≦1.1, and 0≦b≦0.1;
QO₂;
QS₂;
LiQS₂;
V₂O₅;
LiV₂O₅;
LiZO₂;
LiNiVO₄;
Li_{(3-f)}J₂(PO₄)₃,
wherein 0≦f≦2;
Li_{(3-f)}Fe₂(PO₄)₃,
wherein 0≦f≦2;
LiFePO₄; and
lithium titanate.

14. The lithium battery of claim 9, wherein the third active material comprises at least one selected from the group consisting of LiCoO₂, LiMn₂O₄, LiFePO₄, a compound represented by Formula 3 below, and a compound represented by Formula 4 below:
Liₓ(NiₚCO_{q}Mnᵣ)O_{y} Formula 3
LiₙNiₜ₁COₜ₂Alₜ₃Oₘ Formula 4
wherein, in Formula 3, 0.95≦x≦1.05, 0<p<1, 0<q<1, 0<r<1, p+q+r=1, and 0<y≦2; and
wherein, in Formula 4, 0.95≦n≦1.05, 0<t1<1, 0<t2<1, 0<t3<1, t1+t2+t3=1, and 0<m≦2.

15. The lithium battery of claim 9, wherein a weight ratio of the sum of the first and second active materials to the third active material is in a range of about 1:99 to about 50:50.

16. The lithium battery of claim 9, wherein the negative active material comprises a material selected from the group consisting of silicon, a silicon-based composite material, tin, a tin-based composite material, lithium titanate, and a combination of at least two of the foregoing materials.

17. The lithium battery of claim 9, wherein the negative active material comprises silicon oxide.
